(19) United States
(12) Patent Application Publication
(10) Pub. No.: US 2011/0164946 A1
(43) Pub. Date: Jul. 7, 2011

(54) EXPANDING RIVET

(75) Inventors: Martin Büsch, Efringen-Kirchen (DE); Jan Risy, Binzen (DE)

(73) Assignee: A. RAYMOND ET CIE, Grenoble (FR)

(21) Appl. No.: 13/061,563

(22) PCT Filed: Mar. 13, 2010
(86) PCT No.: PCT/EP10/01608

§ 371 Date: Mar. 1, 2011

(30) Foreign Application Priority Data
Mar. 25, 2009 (DE) 10 2009 014 678.4

(51) Int. Cl. F16B 19/10

(52) U.S. Cl. 411/502

(57) ABSTRACT

The invention relates to an expanding rivet having solid cap pieces (14) on expanding legs (3, 4) as pivot structures each haying a sliding surface (14), and having a contact surface (11) already facing a support plate (1) in a relaxed position of the expanding legs (3, 4). When pre-attaching in a secure manner by inserting a rivet pin (2), only a relatively small pivot motion of the expanding legs (3, 4) is required for attaching a contact part (17) on a support part (16).

### CROSS-REFERENCE TO RELATED APPLICATION

This application is a U.S. National Phase patent application based on International Application Serial No. PCT/EP2010/001608 filed Mar. 13, 2010, the disclosure of which is hereby explicitly incorporated by reference herein.

### BACKGROUND OF THE INVENTION

1. Field of the Invention

The present invention relates to an expanding rivet.

2. Description of the Related Art

One known expanding rivet for attaching a contact part on a support part is disclosed in WO 2008/015511 A1. The previously known expanding rivet comprises a support plate and has a rivet pin that is mounted in moveable manner in the support plate. Several expanding legs are connected with the support plate, which legs extend in longitudinal direction from the support plate. The two expanding legs of the previously known expanding rivet each have a pivot structure which protrudes radially to the inside and have a contact surface directed radially to the outside. In the previously known expanding rivet each expanding leg has a hinge which is formed through material diminution. In said previously known expanding rivet the pivot structure of each expanding leg is formed by a pin-shaped pivot lever which is integrally formed at the side of the hinge facing away from the support plate and which extends at right angles away from the respective expanding leg in the direction of the other expanding leg. By moving the rivet pin from a preassembled position in which it is not in contact with the pivot lever into the final assembly position the rivet pin impinges the pivot levers which avoid the rivet pin and swivel by 90 degrees the contact surfaces arranged at the side of the hinge facing away from the support plate from a basically longitudinal arrangement into an arrangement facing the support plate. As a result the support part and the contact part, which are arranged between the support plate and the contact surfaces, are connected with each other.

### SUMMARY OF THE INVENTION

The present invention provides an expanding rivet which, when pre-attached in a secure manner in a preassembled arrangement, is characterized in that it is highly resilient for attaching a contact part to a support part.

By designing the pivot structures of the expanding rivet as solid cap pieces with an oblique sliding surface, and the contact surfaces are already assembled in the arrangement of the rivet pin not affecting the cap pieces and pointing in the direction of the support plate, it is possible with a relatively small pivot motion of the expanding legs to bring the contact surfaces in contact with a support part or a contact part and thus interlock the support part with the contact part. In particular, through the relatively small movement of the contact surfaces with regard to the pivoting angle, it is also possible to design the expanding legs with a basically consistent material thickness and, consequently, with a high resistance capacity toward relatively high extraction forces.

In one form thereof, the present invention provides an expanding rivet including a support plate which has a rivet pin that is mounted in moveable manner in the support plate, and which has several expanding legs that are connected with the support plate and extend in longitudinal direction from the support plate, whereas the expanding legs each have a pivot structure which protrudes radially to the inside, and when the rivet pin is moved in the direction of the expanding legs, the pivot structure upon coming in contact with the rivet pin causes the expanding legs to make a radial move to the outside, and whereas the expanding legs have a contact surface facing radially to the outside, characterized in that the pivot structures are designed as solid cap pieces which are arranged at least in the region of a head section of the respective expanding leg adjoining the support plate and each pivot structure has an oblique sliding surface that protrudes from the support plate in longitudinal direction to the inside, and that the contact surfaces are arranged in such a way that they point in the direction of the support plate where the rivet pin does not act on the sliding surface.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 to FIG. 7 is a first embodiment of an expanding rivet;

FIG. 8 to FIG. 10 is a second embodiment of an expanding rivet;

FIG. 11 to FIG. 13 is a third embodiment of an expanding rivet;

FIG. 14 to FIG. 17 is a fourth embodiment of an expanding rivet;

FIG. 18 to FIG. 24 is a fifth embodiment of an expanding rivet; and

FIG. 25 to FIG. 31 is a sixth embodiment of an expanding rivet.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

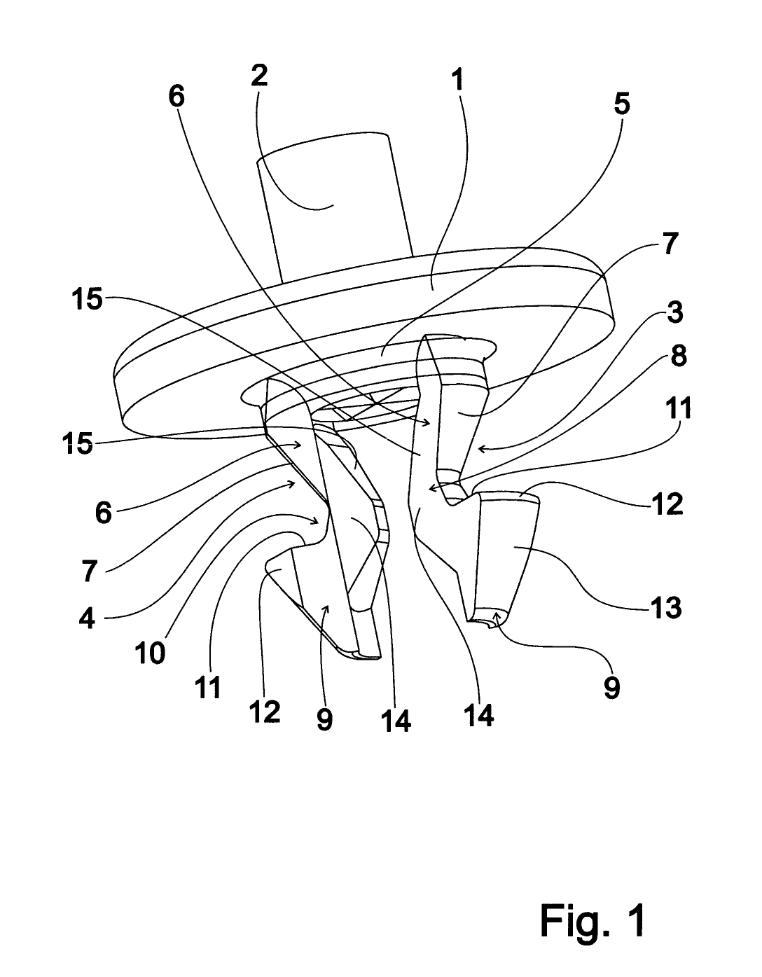

FIG. 1 shows a perspective view of a first embodiment of an expanding rivet. The expanding rivet according to FIG. 1 comprises a disc-like support plate 1 provided with a circular circumference. In the center of the support plate 1 is a receiving recess for a pin in which a cylindrical rivet pin 2 is mounted in such a way that it can be moved in longitudinal direction which extends at right angles to the plane of the support plate 1. In the embodiment according to FIG. 1, the expanding rivet comprises two expanding legs 3, 4 which are arranged offset in transverse direction and opposite to each other and are connected with the support plate 1 by means of an annular collar 5 which is integrally formed to the support plate 1 and which surrounds the receiving recess for the pin.

Each expanding leg 3, 4 comprises a head section 6 which is connected to the annular collar 5 and which extends radially to the inside away from the annular collar 5 of the support plate 1 and oblique to the longitudinal direction and which has an outer surface 7 facing away from the support plate 1. Each side of the head section 6 facing away from the support plate 1 has a relatively short central section 8 in comparison to the head section 6 which central section 8 basically extends in a longitudinal direction.

Furthermore, each expanding leg 3, 4 comprises a foot section 9 integrally formed to the respective central section 8 which foot section 9 closes the respective expanding leg 3, 4 on the side facing away from the support plate 1. Each foot section 9 protrudes radially to the outside toward the head section 6 and the central section 8 forming a radial constriction 10 in the region of the central section 8. At the same time a contact surface 11 extending basically at right angles to the longitudinal direction and, consequently, basically parallel to the support plate 1 closes a rear grip lug 12 of the respective expanding leg 3, 4. Furthermore, each foot section 9 comprises an inclined plane 13 facing radially to the outside, which inclined plane 13 extends oblique to the longitudinal direction radially to the inside facing away from the outer radial edge of the respective contact surface 11 of the support plate 1.

At the side facing radially to the inside, each expanding leg 3, 4 has a pivot structure in the form of a solid cap piece 14, which extends in longitudinal direction on both sides of the respective central section 8 in the direction of the head section, as well as in the direction of the foot section 9. The cap pieces 14 are positioned in transverse direction in offset planes. On the side of the head section 8 each cap piece 14 is provided with a sliding surface 15 which faces away from the support plate 1 and which extends in longitudinal direction obliquely radially to the inside.

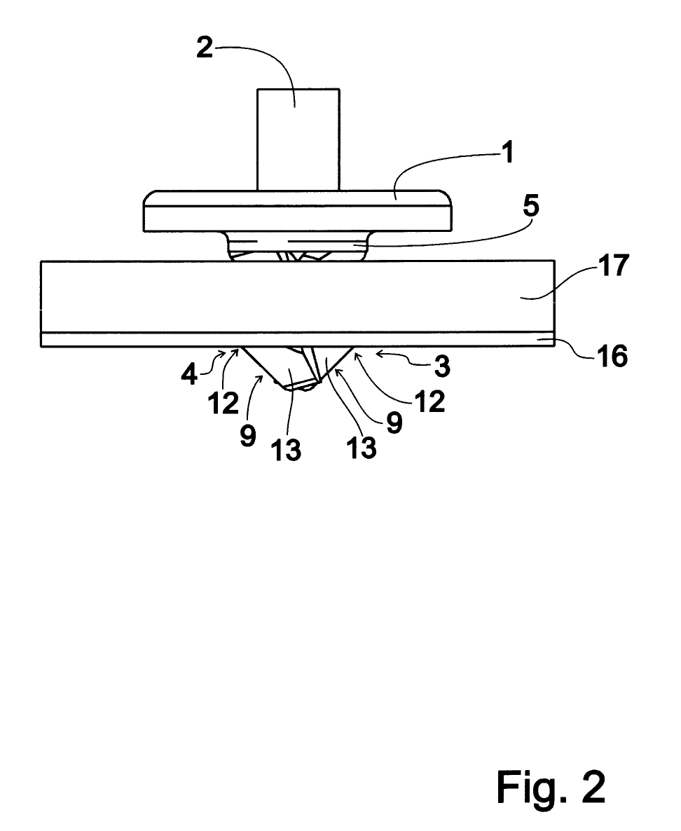

FIG. 2 shows a side view of the embodiment according to FIG. 1 together with a flat support part 16 and a contact part 17 that is thicker than the support part 16, both of which are designed with a receiving recess for the pin. In the arrangement according to FIG. 2, the expanding rivet is inserted in the support part 16 and the contact part 17 to the extent that the rear grip lugs 12 are arranged approximately in the region of the support part 16. The representation in FIG. 2 shows that, compared with the relaxed arrangement according to FIG. 1, in this arrangement the expanding legs 3, 4 were compressed to the inside because of the pressure the edge of the receiving recesses exerted on the inclined planes 13 and were passing each other because of the offset arrangement in transverse direction of the expanding legs 3, 4, as well as the cap pieces 14. Consequently, the offset arrangement in transverse direction of the expanding legs 3, 4 results in the fact that each expanding leg 3, 4 is turned to a certain extent.

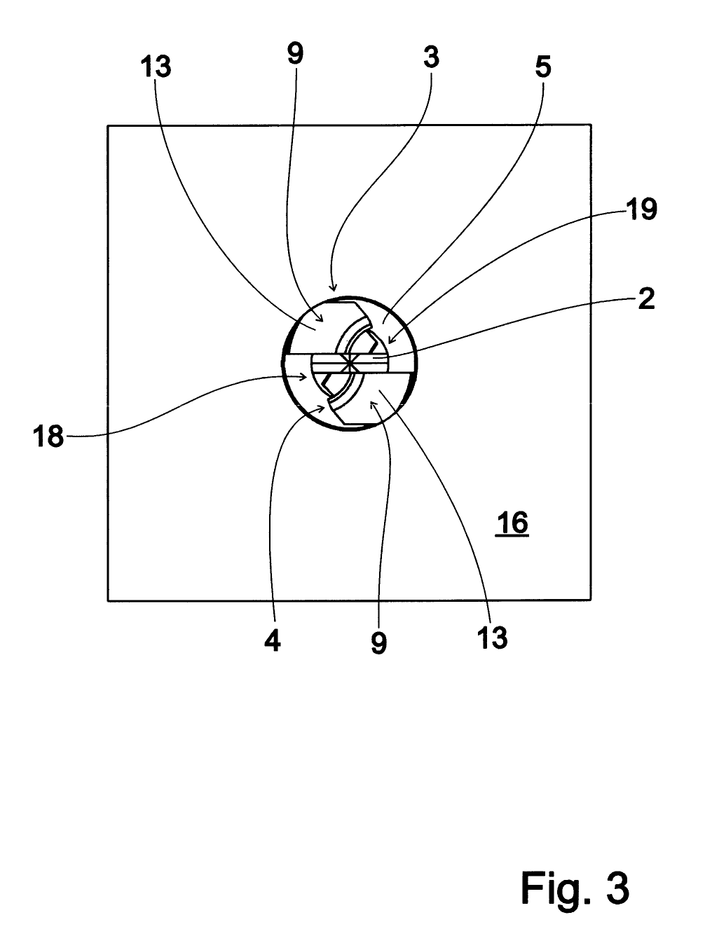

FIG. 3 shows the foot sections 9 of an embodiment of the expanding rivet represented in FIG. 1 according to the arrangement represented in FIG. 2. FIG. 3 shows that the expanding legs 3, 4 can pass each other smoothly when they are inserted in the receiving recess 18 formed in the support part 16 and the receiving recess 19 formed in the contact part 17.

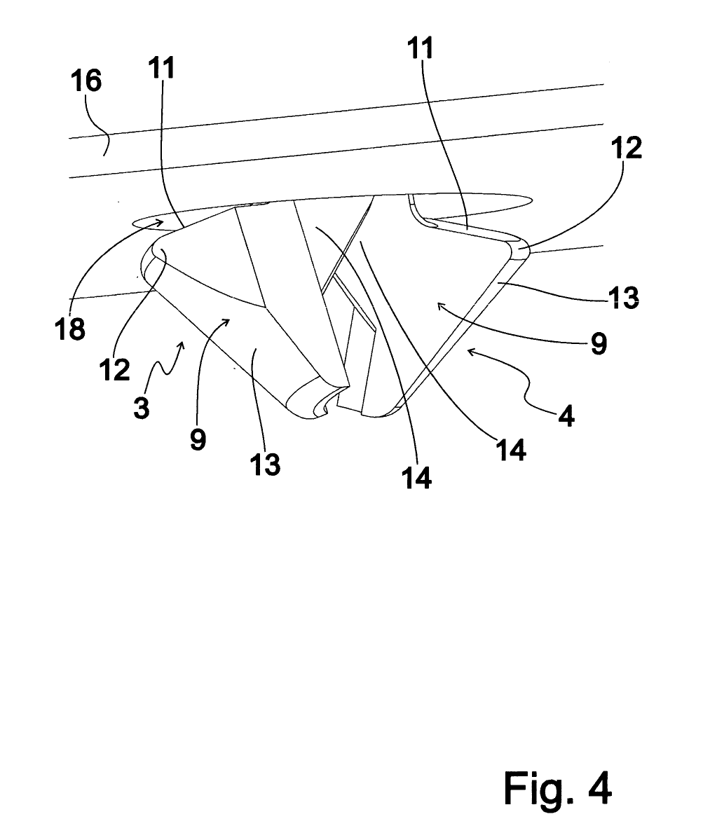

FIG. 4 shows a perspective view of the first embodiment of an expanding rivet after the foot sections 9 of the expanding legs 3, 4 have passed through the receiving recess 18 formed in the support part 16. FIG. 4 shows that the rear grip lugs 12 have now completely passed through the receiving recess 18 formed in the support part 16, and that the expanding legs 3, 4 are again in the spaced-apart, relaxed arrangement according to FIG. 1. In this relaxed arrangement, the rear grip lugs 12 engage behind the edge of the receiving recess formed in the support part 16 on the surface facing away from the contact part 17. As a result, the expanding rivet is retained in a secure manner in the arrangement consisting of support part 16 and contact part 17.

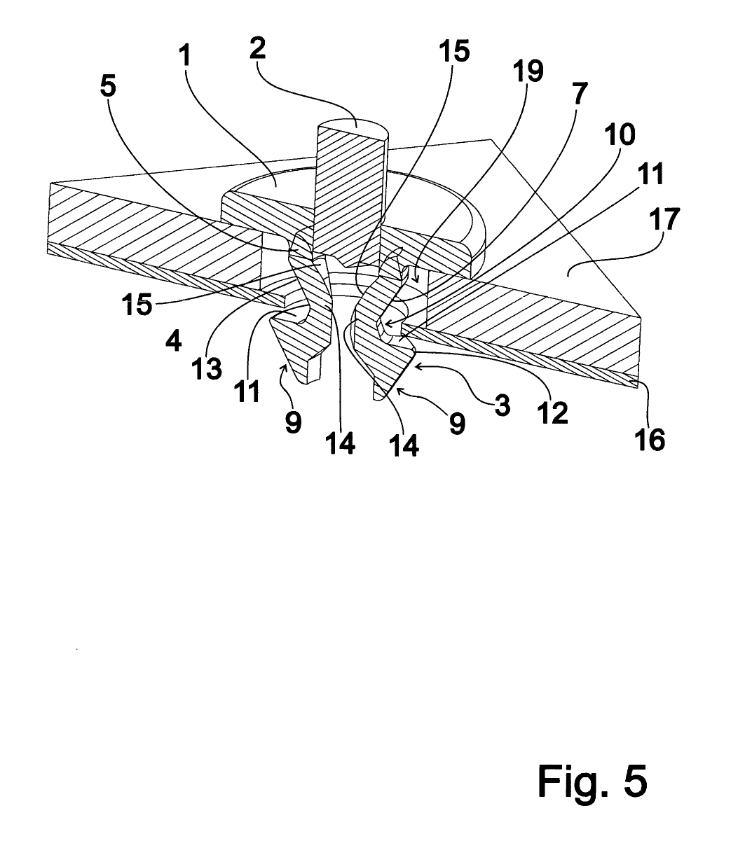

FIG. 5 shows a sectional, perspective view of an embodiment of the expanding rivet according to FIG. 1 when the expanding rivet has passed through the receiving recesses 18, 19 of the support part 16 or the contact part 17, with the expanding rivet being in preassembled position. FIG. 5 shows particularly clearly that the sliding surfaces 15 taper in a wedge shape facing away from the support plate 1 so that from the first contact of the expanding rivet 2 with the sliding surfaces 15 of the cap pieces the expanding legs 3, 4 can be moved radially to the outside by continually moving the expanding rivet 2 from the preassembled position according to FIG. 5 in the direction of the expanding legs 3, 4.

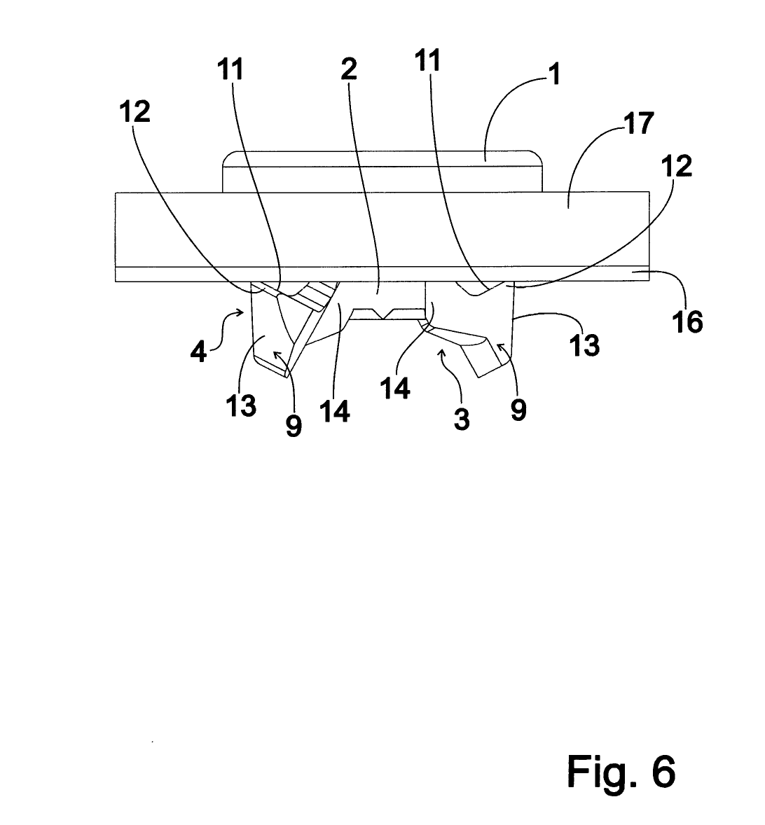

FIG. 6 shows a side view of an embodiment of the expanding rivet according to FIG. 1 when the expanding rivet is completely inserted in the support part 16 and the contact part 17, with the expanding rivet 2 being in a completely inserted final assembly position. In the final assembly position of the expanding rivet 2, the expanding legs 3, 4 are now radially folded to the outside so that the rear grip lugs 12 rest against the surface of the support part 16 facing away from the contact part 17. Because of the resilience of the expanding legs 3, 4, the contact part 17 is pressed with a certain pressure force over the support plate 1 designed as a counter-support against the support part 16.

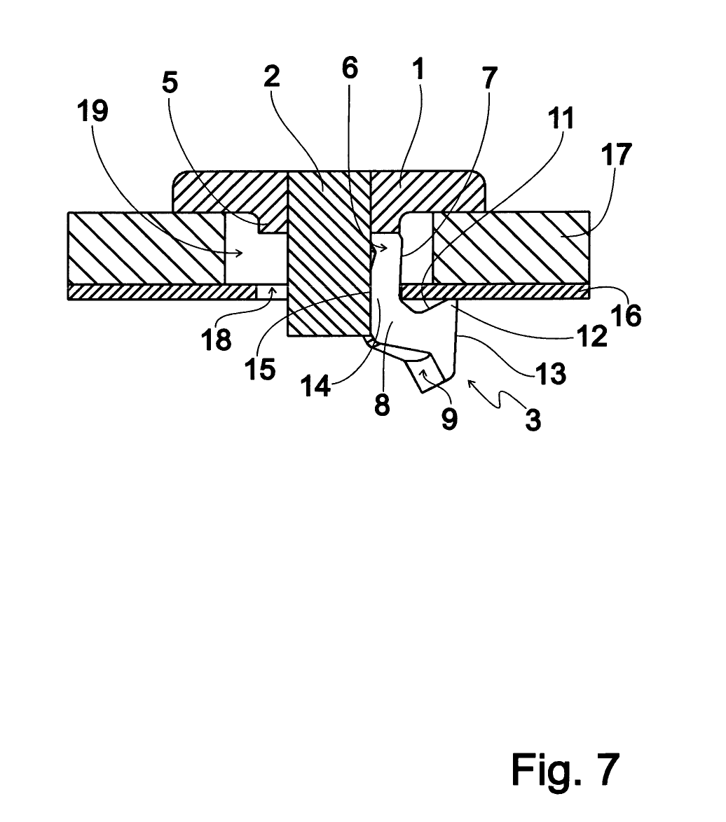

FIG. 7 shows a sectional view of an embodiment of the expanding rivet represented in FIG. 1 according to the arrangement represented in FIG. 6. FIG. 7 shows that in the final assembly position of the expanding rivet 2 the outer surfaces 7 at the edge of the receiving recess 18 of the support part 16 and the sliding surfaces 15 rest almost completely against the outer surface of the expanding rivet 2, with the expanding legs 3, 4 being folded with a certain torsion radially to the outside.

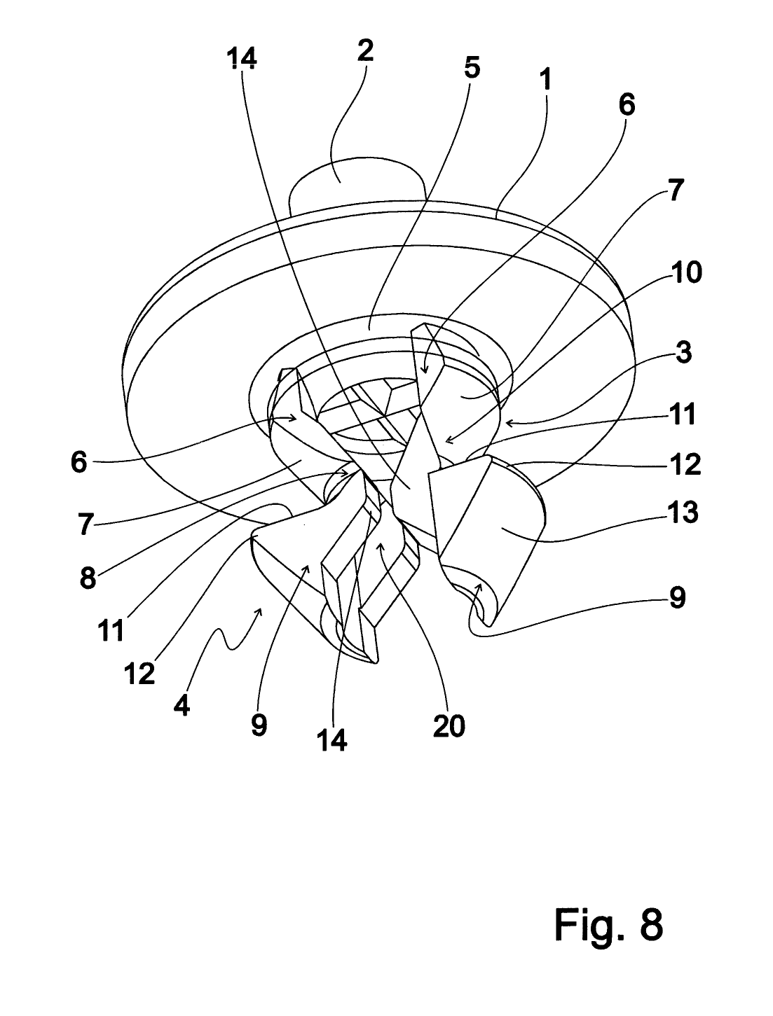

FIG. 8 shows a perspective view of a second embodiment of the expanding rivet. Because of the fact that the expanding rivets according to the first embodiment shown in FIG. 1 to FIG. 7 involve elements that are corresponding with those of the second embodiment according to FIG. 8, which also have the same reference numerals, they will for the most part not be explained in detail. In the second embodiment according to FIG. 8, both expanding legs 3, 4 are arranged directly opposite from each other and are not offset in transverse direction. In the second embodiment, one expanding leg 3 has one single cap piece 14 designed as a pivot structure while the other expanding leg 4 has two cap pieces 14 designed as pivot structures which, by forming a receiving chamber 20 in transverse direction, are arranged at a distance from one another. The receiving chamber 20 is dimensioned in such a way that the cap piece 14 of the other expanding leg 3 is almost completely arranged in the receiving chamber 20.

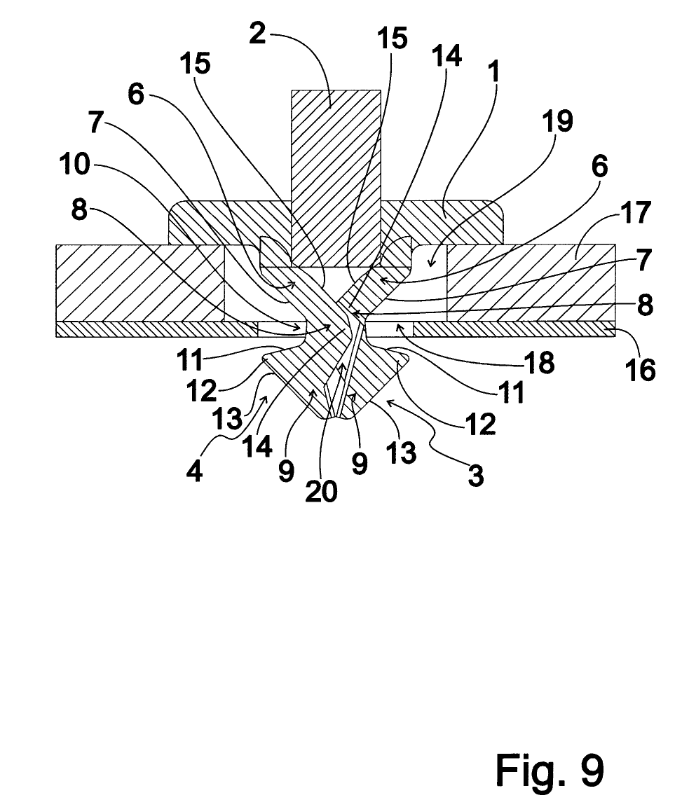

FIG. 9 shows a sectional view of the second embodiment according to FIG. 8 in which a support part 16 and a contact part 17 are arranged in receiving recesses 18, 19 immediately after the rear grip lugs 12 passed through the receiving recess 18 formed in the support part 16 before the expanding legs 3, 4 again relaxed and rebound to the outside. FIG. 9 shows that the receiving chamber 20 provides for the compression of the expanding legs 3, 4 required for a pre-attachment in a secure manner according to the first embodiment according to FIG. 1.

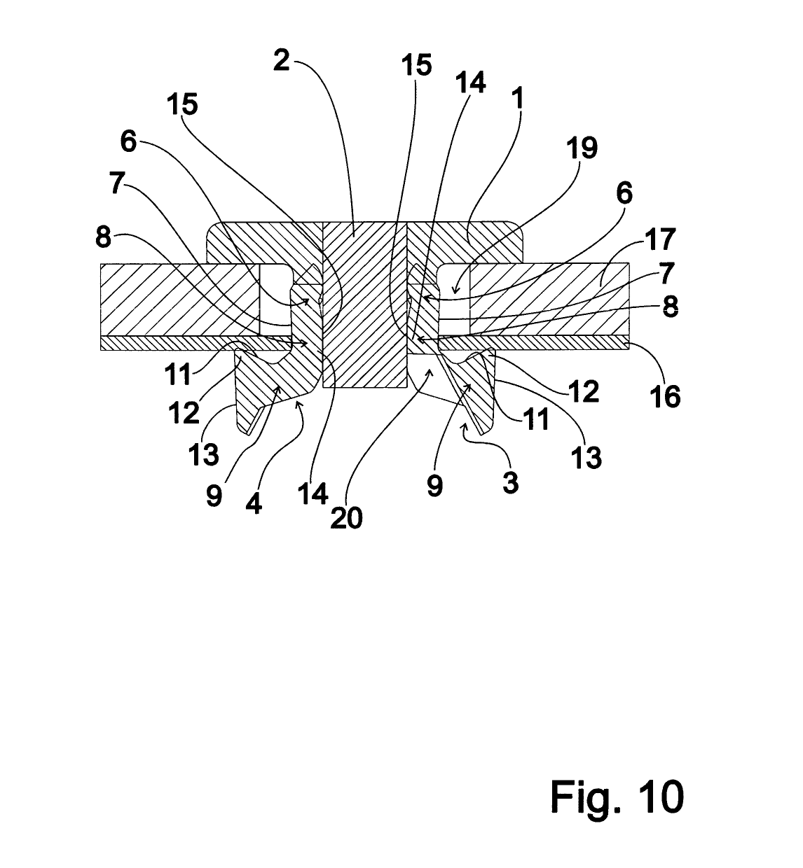

FIG. 10 shows a sectional view of the second embodiment according to FIG. 8 in which the arrangement is inserted in the receiving recesses 18, 19 of the support part 16 and the contact part 17, with the rivet pin 2 in the final assembly position, in which corresponding to the arrangement of the first embodiment according to FIG. 6 and FIG. 7 the rear grip lugs 12 of the expanding legs 3, 4 generate a contact pressure between the contact part 17 and the support part 16 over the support plate 1 and rest against the surface of the support part 16 facing away from the contact part 17.

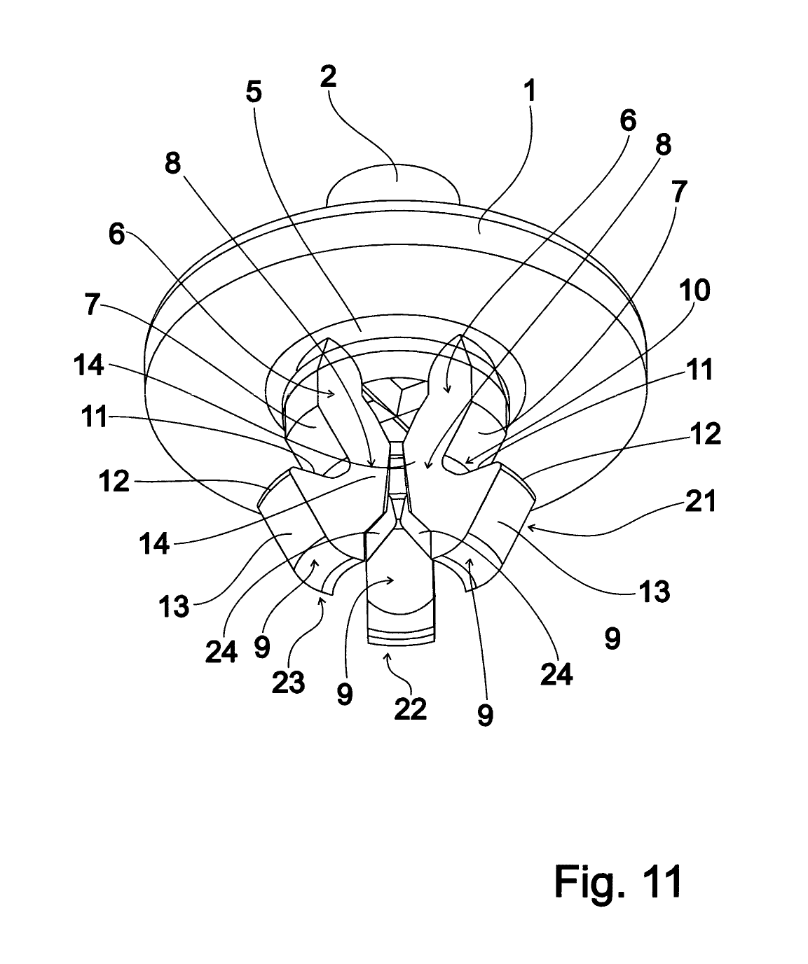

FIG. 11 shows a perspective view of a third embodiment of the expanding rivet. Because of the fact that the expanding rivets according to the first embodiment shown in FIG. 1 to FIG. 7 involve elements that are corresponding with those of the second embodiment according to FIG. 8 to FIG. 10 and the third embodiment according to FIG. 11, which also have the same reference numerals, they will for the most part not be explained in detail. The third embodiment shown in FIG. 11 comprises three expanding legs 21, 22, 23 arranged at an angle of 12-degrees. In the first embodiment according to FIG. 1 to FIG. 7, each of the expanding legs is provided with a cap piece 14 designed as a pivot structure. In the embodiment according to FIG. 11, the cap pieces 14 have a flat sloping side 24 at the sides facing each other.

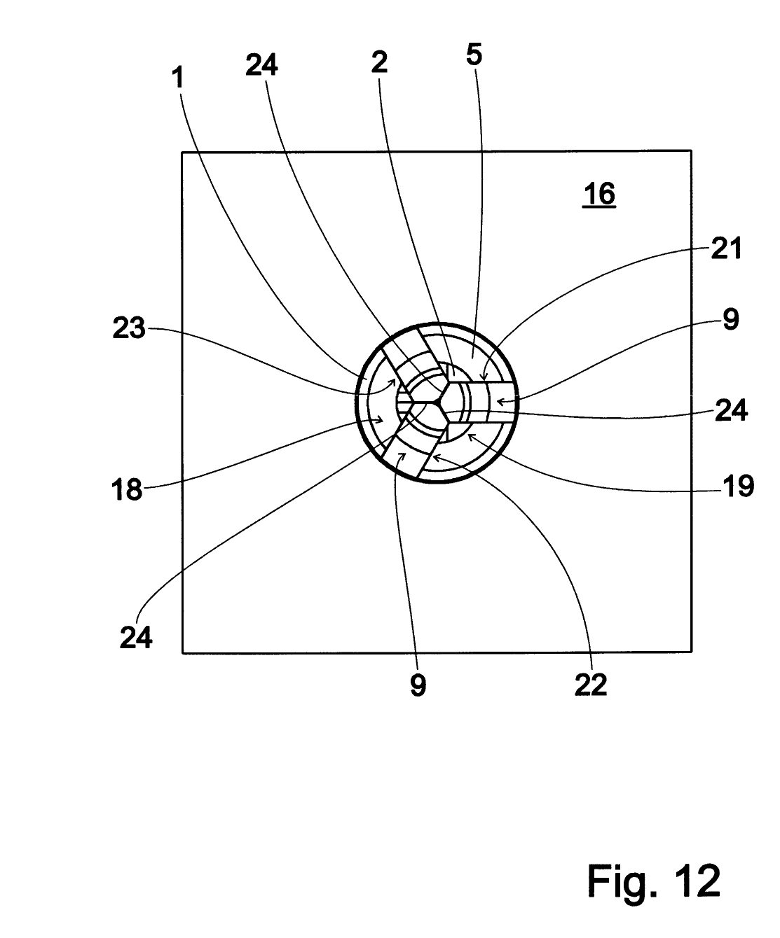

FIG. 12 shows the expanding rivet of the third embodiment represented in FIG. 11 in an arrangement according to FIG. 3 of the first embodiment, viewing the foot sections 9 in which the expanding rivet is inserted in receiving recesses 18, 19 of a support part 16 and a contact part 17 and the rear grip lugs 17 are arranged in the region of the edge of the receiving recess 18 formed in the support part 16 and exactly corresponding to the minimal nominal diameter. In this arrangement the surfaces of the sloping sides 24 of the cap pieces 14 completely rest against each other.

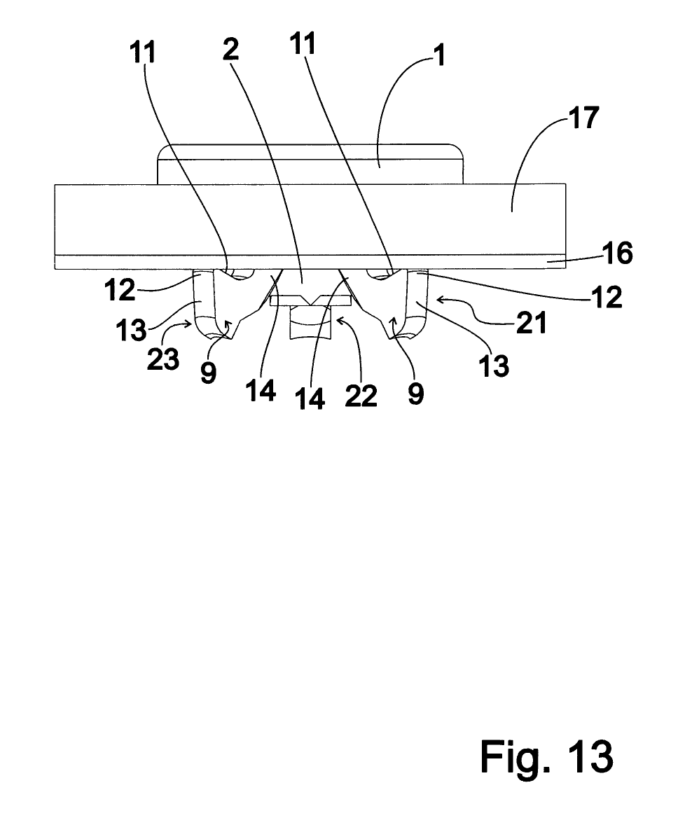

FIG. 13 shows a side view of the third embodiment according to FIG. 11 and FIG. 12, with the rivet pin 2 being completely inserted in the final assembly position for pressing the contact part 17 on the support part 16 corresponding to the arrangements according to FIG. 6 and FIG. 7 in the case of the first embodiment, or according to FIG. 10 in the case of the second embodiment. According to the third embodiment, by providing three expanding legs 21, 22, 23, the extraction force of the expanding rivet is relatively high.

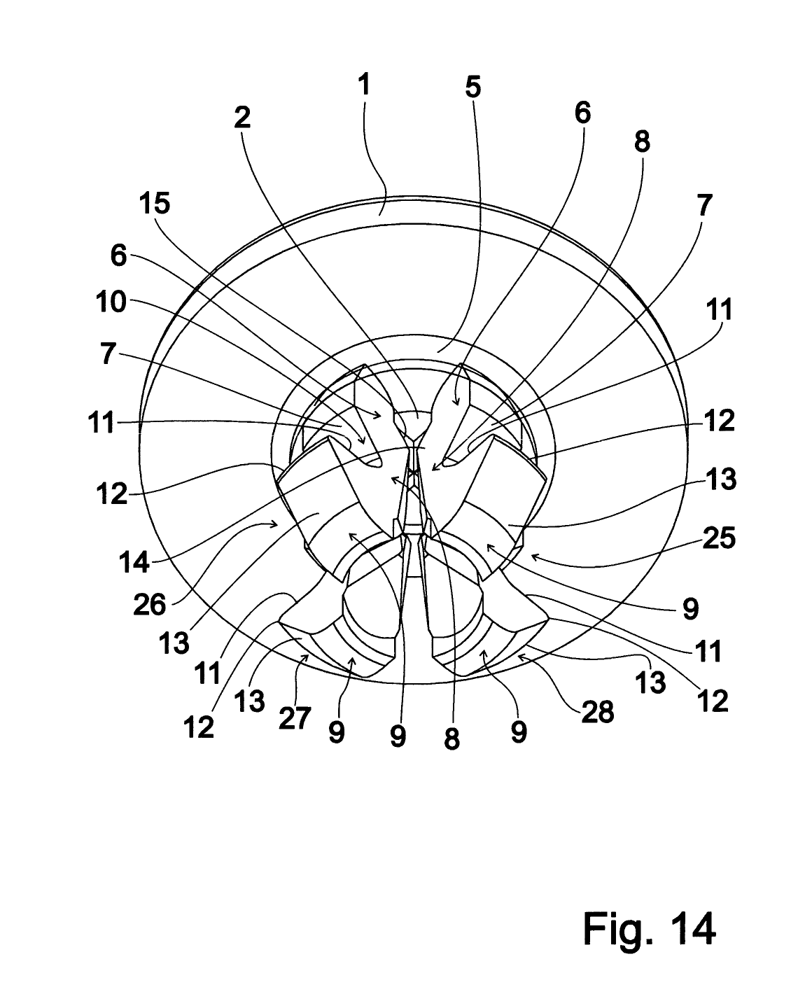

FIG. 14 shows a perspective view of a fourth embodiment of the expanding rivet. Because of the fact that the expanding rivets according to the first embodiment shown in FIG. 1 to FIG. 7 involve elements that are corresponding with those of the second embodiment shown in FIG. 8 to FIG. 10, the third embodiment shown in FIG. 11 to FIG. 13, and the fourth embodiment shown in FIG. 14, which also have the same reference numerals, they will for the most part not be explained in detail. The fourth embodiment according to FIG. 14 is provided with four expanding legs 25, 26, 27, 28 arranged at a distance of 90 degrees which, corresponding with the third embodiment according to FIG. 11 to FIG. 13 each comprise a cap piece 14 designed as a pivot structure and having sloping sides 24 on both sides.

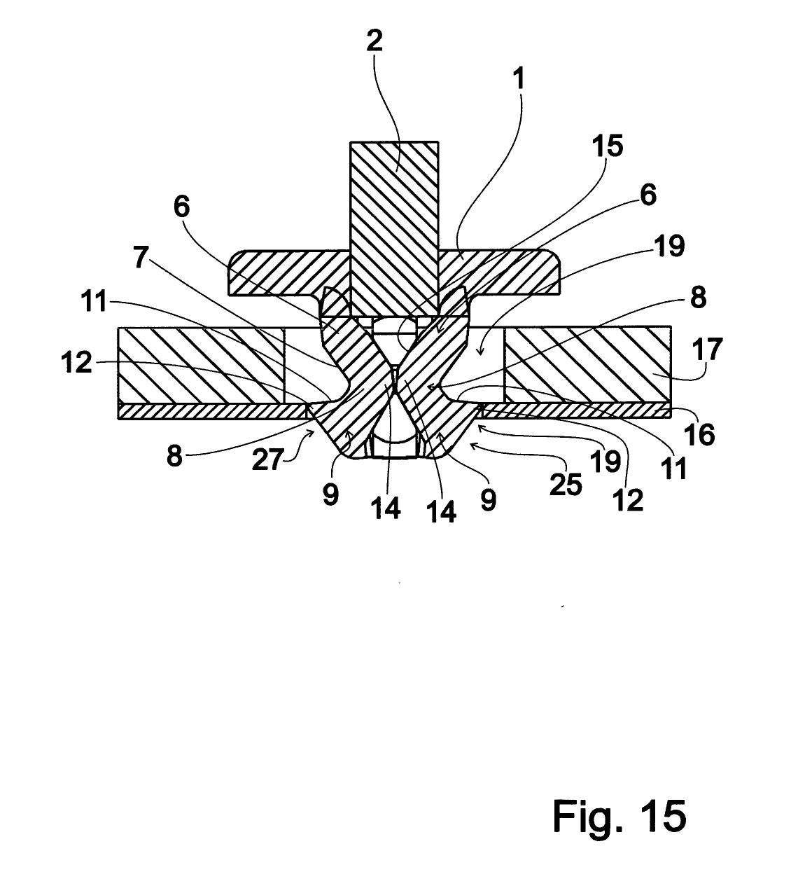

FIG. 15 shows a sectional side view of the fourth embodiment according to FIG. 14 with the expanding legs 25, 26, 27, 28 being inserted in receiving recesses 18, 19 formed in a support part 16 and in a contact part 17, in a position in which, because of the contact the rear grip lugs 12 have with the edge of the receiving recess 18 formed in the support part 16, the expanding legs 25, 26, 27, 28 that are touching the respective sloping side 24 of the adjacent cap piece 14 have a minimal diameter in the region of the rear grip lugs 12.

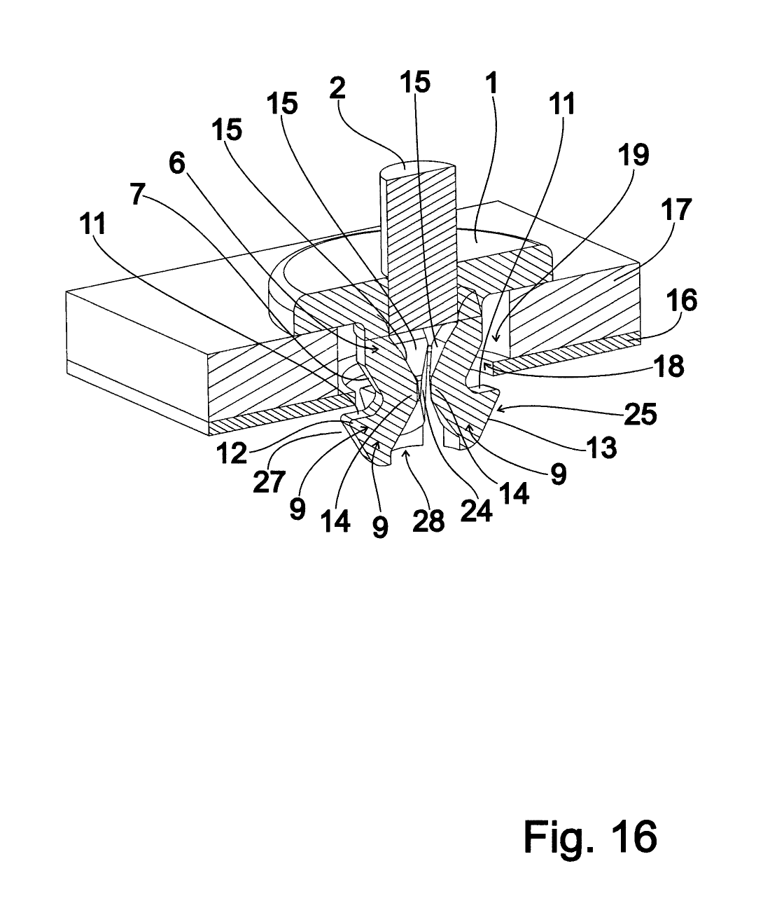

FIG. 16 shows a sectional perspective view of the fourth embodiment according to FIG. 14 and FIG. 15 in which the pre-assembly arrangement is completely inserted in a secure manner in the support part 16 and the contact part 17. In said pre-assembly arrangement, the expanding legs 25, 26, 27, 28 are again in the relaxed arrangement, with the rear grip lugs 12 engaging behind the edge of the receiving recess 18 formed in the support part 16.

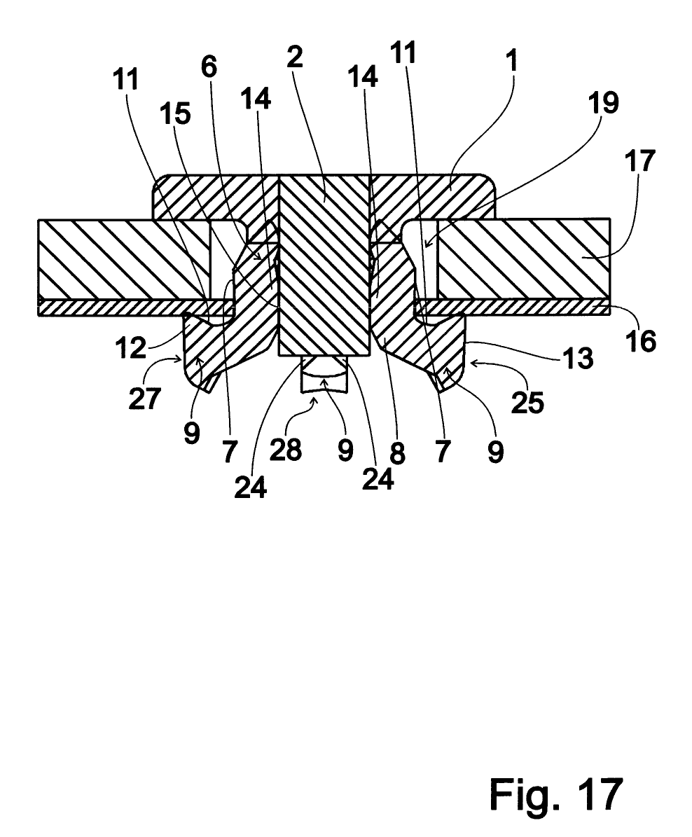

Finally, FIG. 17 shows a sectional side view of the fourth embodiment with the rivet pin 2 being in an inserted final assembly position, in which the four expanding legs 25, 26, 27, 28 generating an especially high extraction force rest against the surface of the support part 16 facing away from the contact part 17 and by means of the pressure the support plate exerts on the contact part 17 the contact part 17 is connected with the support part 16.

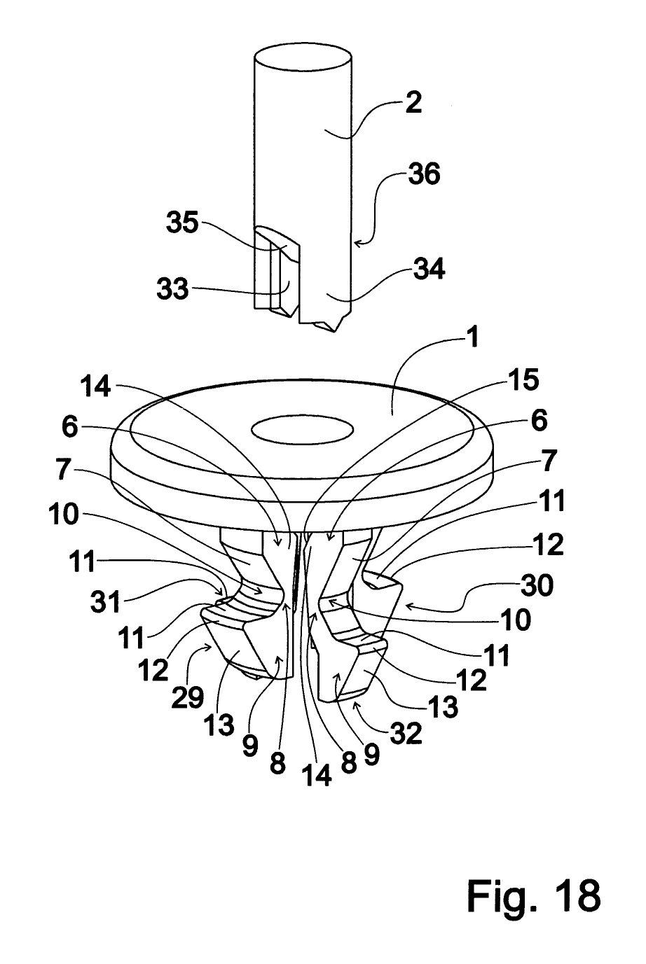

FIG. 18 shows a perspective view of a fifth embodiment of the expanding rivet in which the expanding rivets according to the embodiments represented in FIG. 1 to FIG. 17 involve elements that are corresponding with those of the fifth embodiment according to FIG. 18, which also have the same reference numerals and will therefore for the most part not be explained in detail. The fifth embodiment according to FIG. 18 comprises a pair of shorter expanding legs 29, and a pair of longer expanding legs 31, 32, whereas the expanding legs 29, 30, 31, 32 of a pair of equal length are located diagonally opposite of each other. The contact surfaces 11 of the shorter expanding legs 29, 30 are closer to the support plate 1 than the contact surfaces 11 of the longer expanding legs 31, 32. Moreover, the shorter expanding legs 29, 30 have a larger circumferential dimension than the longer expanding legs 31, 32.

The basically completely cylindrical rivet pin 2 of the embodiment according to FIG. 18 is provided for the intended arrangement with protruding pin legs 33, 34 on one insertion end facing the expanding legs 29, 30, 31, 32. Between said pin legs 33, 34 a pin ramp 35, 36 is formed, which in this embodiment is chamfered.

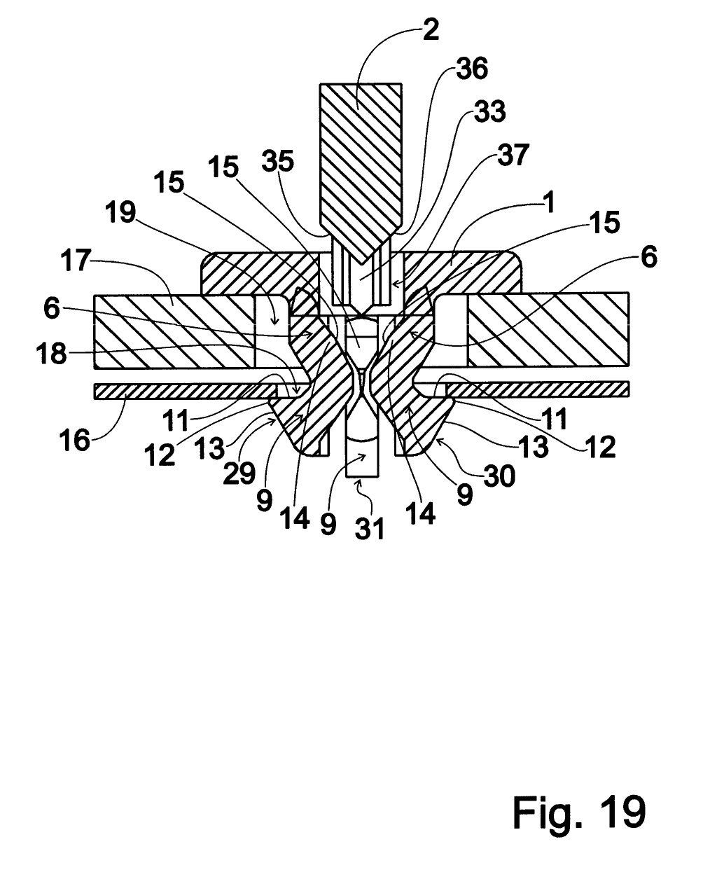

FIG. 19 shows the expanding rivet according to FIG. 18 in cross-section through the shorter expanding legs 29, 30 in an arrangement in which the expanding rivet is inserted in receiving recesses 18, 19 of a support part 16 or a contact part 17. In said arrangement, edge regions of the contact surfaces 11 of the shorter expanding legs 29, 30 engage behind the surface of the support part 16 facing away from the contact part 17 and the support plate 1 rests on the surface of the contact part 17 facing away from the support part 16. At the same time, it is possible that the support part 16 and the contact part 17 are still spaced apart from each other. The pin legs 33, 34 of the rivet pin 2 are inserted in a receiving recess for a pin 37 formed in the support plate 1.

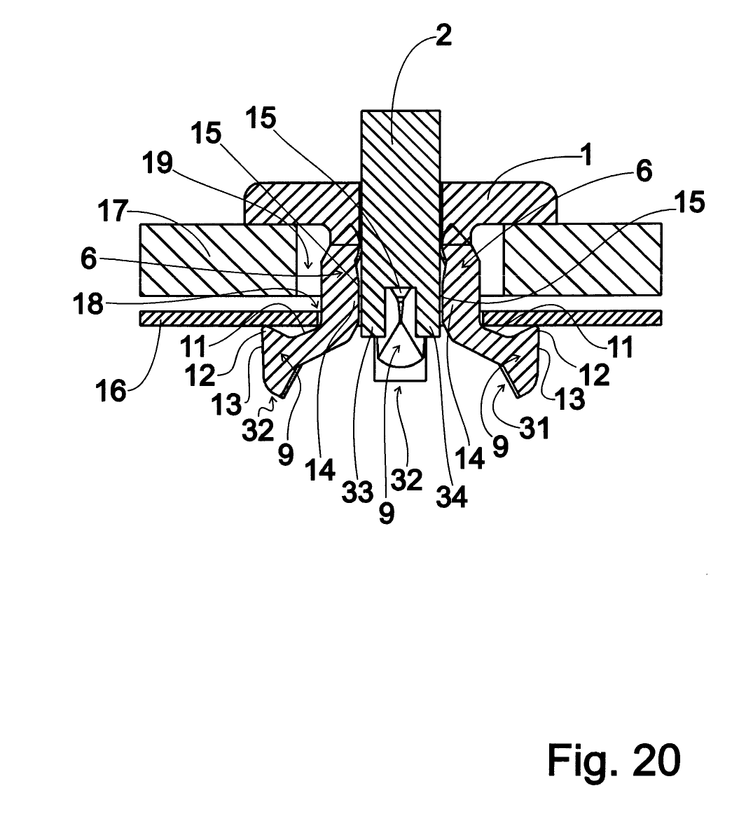

FIG. 20 shows the embodiment according to FIG. 18 in cross-section through the longer expanding legs 31, 32 in an arrangement corresponding to FIG. 19, whereas in the arrangement according to FIG. 20 the rivet pin 2 is inserted in the direction of the expanding legs 29, 30, 31, 32 to the extent that the pin legs 33, 34 act on the sliding surfaces 15 of the longer expanding legs 31, 32 and their respective foot section 9 is folded over the central section 8 and, by means of the rear grip lug 12, are brought in contact with the surface of the support part 16 facing away from the contact part 17. In this arrangement, the contact part 17 is already pre-attached with a relatively high retention force to the support part 16.

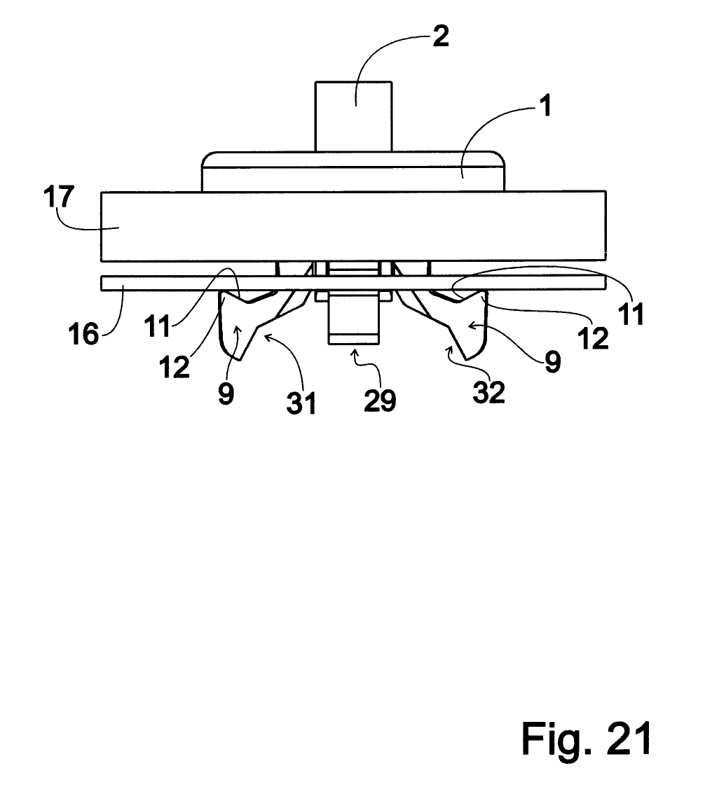

FIG. 21 shows a side view of the arrangement according to FIG. 20 which shows that the shorter expanding legs 29, 30 continue to engage behind the support part 16 on the surface facing away from the contact part 17 even when the rivet pin 2 is only partially inserted in the support plate 1.

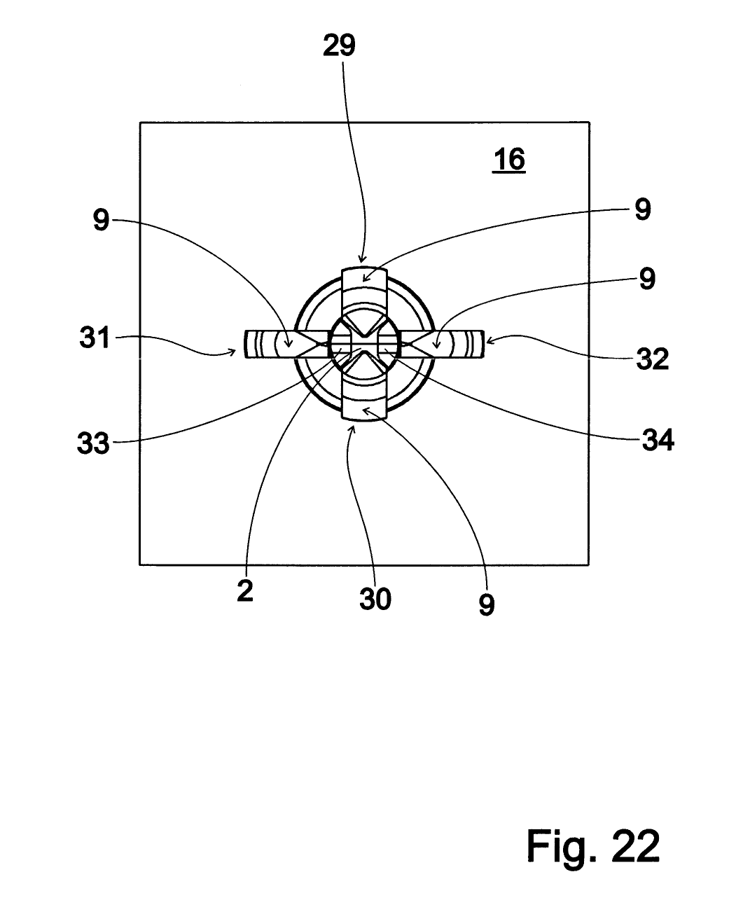

FIG. 22 shows in a top view, on the surface of the support part 16 facing away from the contact part 17, the arrangement of the shorter expanding legs 29, 30 and the longer expanding legs 31, 32, demonstrating that the pairs of expanding legs 29, 30, 31, 32 engage behind the support part 16 in a clearly different manner.

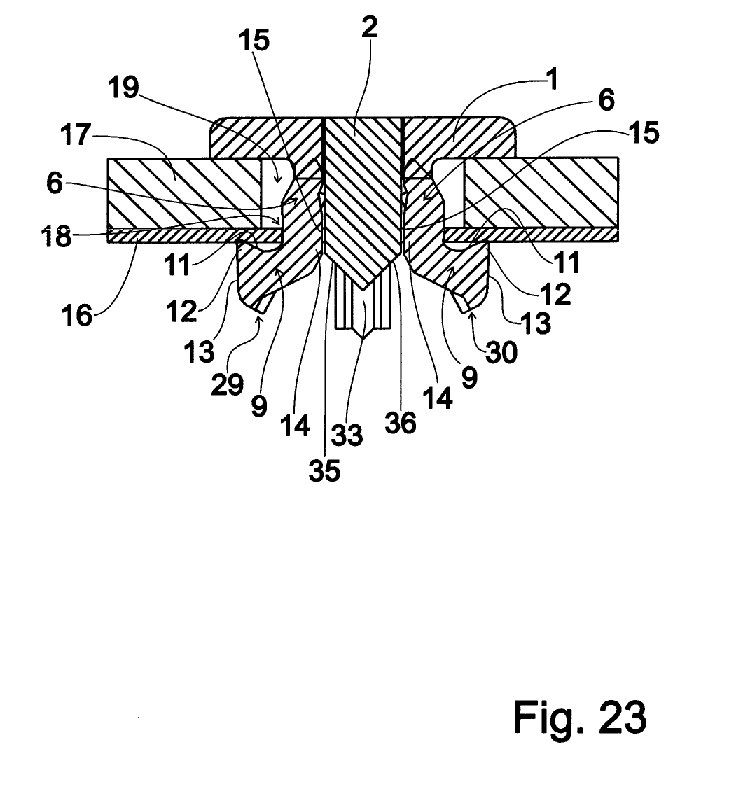

FIG. 23 shows the embodiment according to FIG. 18 in an arrangement corresponding to FIG. 19 to FIG. 22 showing a cross-section through the shorter expanding legs 29, 30 in which the rivet pin 2 is completely lowered in the support plate 1. In this arrangement, the end of the rivet pin 2 facing away from the pin legs 33, 34 is flush with the surface of the support plate 1 facing away from the contact part 17. In this position of the rivet pin 2, with the pin ramps 35, 36 located on the rear side of the pin legs 33, 34, said rivet pin 2 acts on the sliding surfaces 15 of the shorter expanding legs 29, 30 so that said shorter expanding legs also rest with their rear grip lug 12 formed at the respective foot section 9 against the surface of the support part 16 facing away from the contact part 17, thus pressing the contact part 17 against the support part 16.

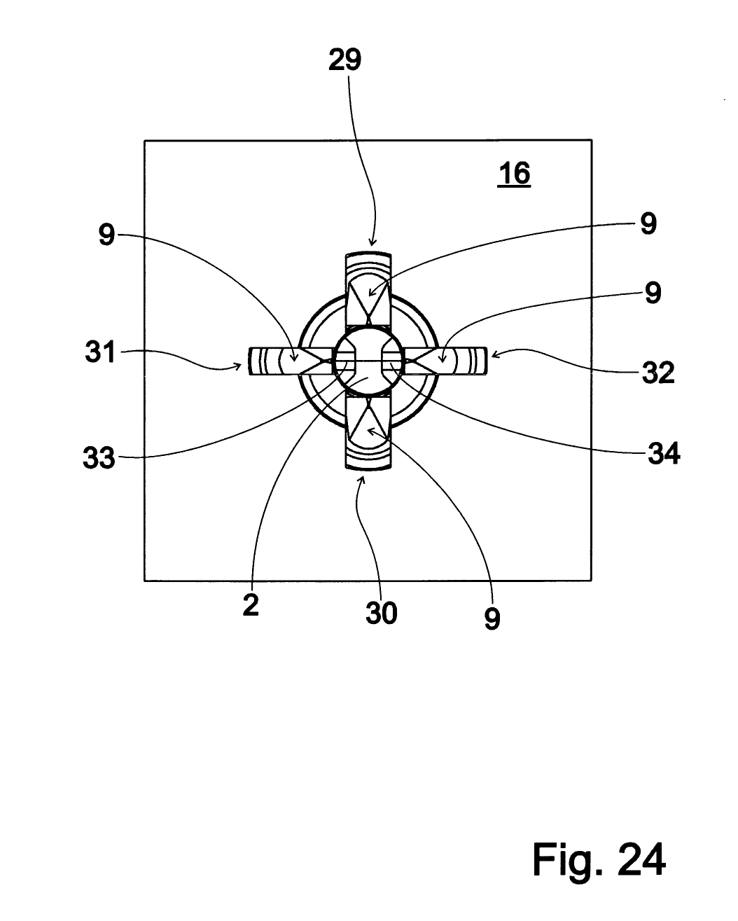

FIG. 24 shows the embodiment according to FIG. 18 in an arrangement corresponding to FIG. 23 showing a top view on the surface of the support part 16 facing away from the contact part 17. FIG. 24 shows that when the rivet pin 2 has been completely inserted the shorter expanding legs 29, 30 also extensively engage behind the surface of the support part 16 facing away from the contact part 17 in order to achieve maximum retention force.

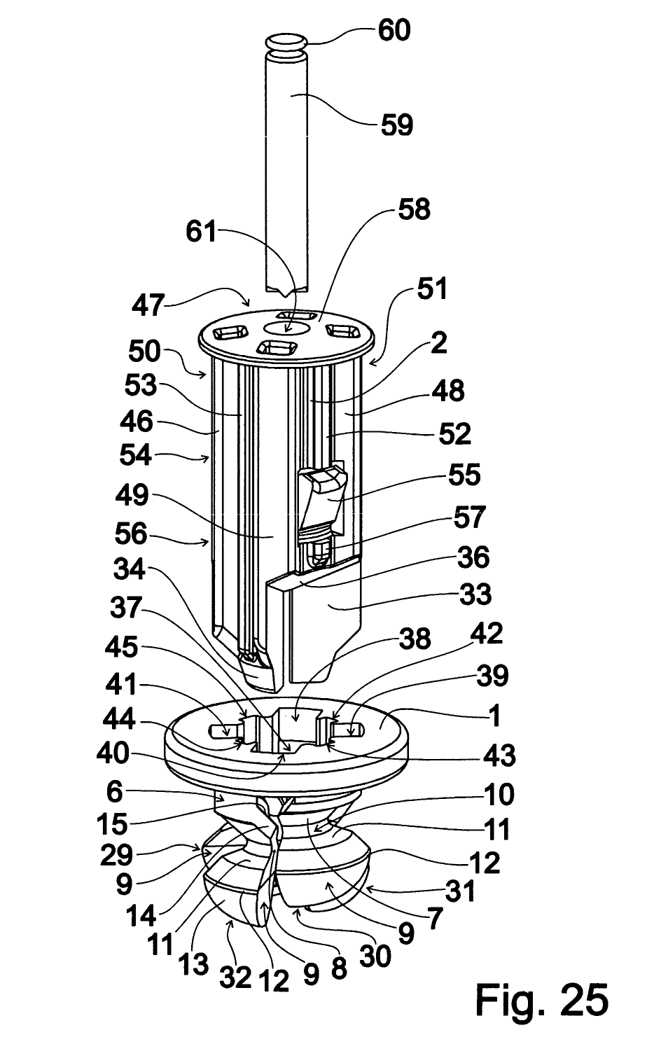

FIG. 25 shows a perspective view of a sixth embodiment of the expanding rivet. Because of the fact that the previously discussed embodiments shown in FIG. 1 to FIG. 24 involve elements that are corresponding with those of the sixth embodiment shown in FIG. 25, which also have the same reference numerals, they will for the most part not be explained in detail. Corresponding with the fifth embodiment according to FIG. 18 to FIG. 24, the embodiment according to FIG. 25 is provided with pairs of expanding legs 29, 30, 31, 32 having different lengths. In the support plate 1, the receiving recess for a pin 37 comprises an arrangement of wide guiding grooves 38, 39, 40, 41 extending in longitudinal direction and narrow guiding grooves 42, 43, 44, 45 arranged between adjacent wide guiding grooves 38, 39, 40, 41. At the same time, in circumferential direction, the distances between one wide guiding groove 38, 39, 40, 41 and the adjacent wide guiding grooves 38, 39, 40, 41 are designed in different pairs.

The rivet pin 2 of the embodiment according to FIG. 25 comprises four broad guide ribs 46, 47, 48, 49 which with an appropriate arrangement of the rivet pin 2 align with the wide guiding grooves 38, 39, 40, 41. In the rivet pin 2 according to FIG. 25, small guide ribs 50, 51, 52, 53 are located between the broad guide ribs 46, 47, 48, 49, which respectively align with the narrow guiding grooves 42, 43, 44, 45. When the larger and smaller distances between the wide guiding grooves 38, 39, 40, 41 and the narrow guiding grooves 50, 51, 52, 53 are paired with the same dimensions, it is possible to insert the rivet pin 2 in the receiving recess for a pin 37 in two adjustments offset by 180 degrees. Between two broad guide ribs 46, 47, 48, 49 spaced further apart, the rivet pin 2 comprises a flexible locking tab 54, 55 tilted to the outside, respectively, each of which is respectively located between the pin ramps 35, 36 provided between two protruding pin legs 33, 34 and the end facing away from the pin legs 33, 34. Between the locking tabs 54, 55 and the pin ramps 35, 36, a respective end section 56, 57 of small guide ribs 50, 52 is provided to support the insertion of the rivet pin 2. At the end facing away from the pin legs 33, 34, the rivet pin 2 has a head plate 58 which protrudes radially to the outside over the broad guide ribs 46, 47, 48, 49.

Furthermore, FIG. 25 shows that the expanding rivet corresponding with the sixth embodiment basically has a cylindrical blocking pin 59 which is provided on one end with a grip edge 60. The blocking pin 59 is dimensioned in such a way that it can be inserted in a recess for a blocking pin 61 formed in the rivet pin 2 and moved in the direction of the pin legs 33, 34.

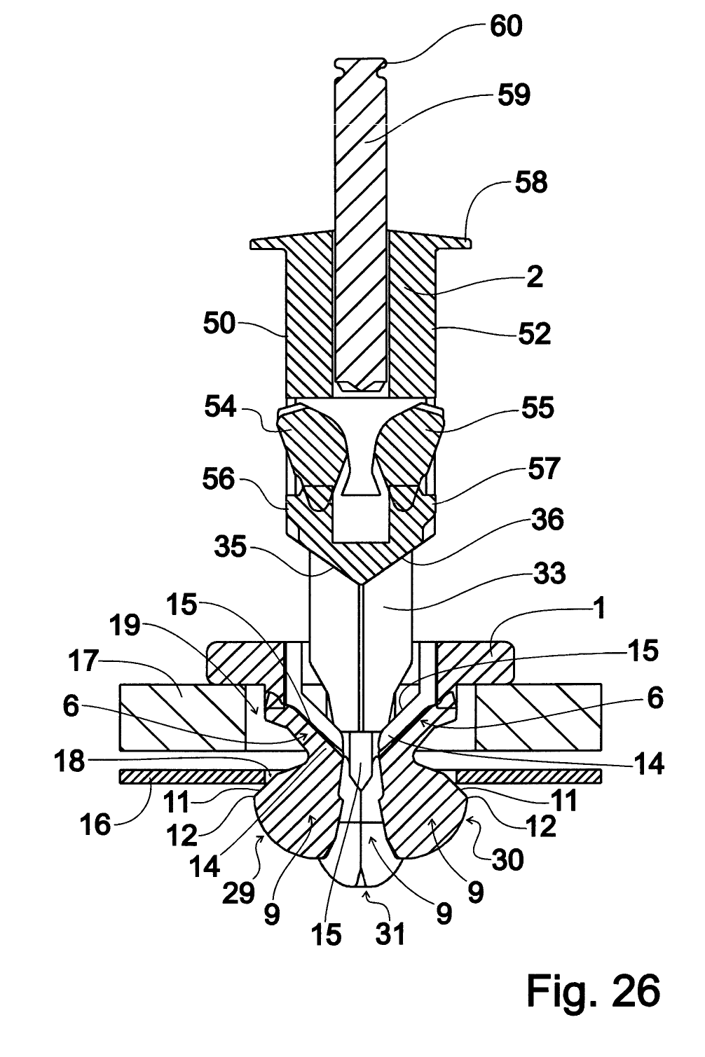

FIG. 26 shows the sixth embodiment in accordance with FIG. 25 in cross-section through the shorter expanding legs 29, 30 in an arrangement in which the expanding rivet is inserted in receiving recesses 18, 19 of a support part 16 or a contact part 17. According to the arrangement of the fifth embodiment shown in FIG. 19, edge regions of the contact surfaces 11 engage behind the surface of the support part 16 facing away from the contact part 17. The pin legs 33, 34 are partially inserted in the support plate 1, while the blocking pin 59 is inserted in the rivet pin 2 to the extent that its end facing away from the grip edge 60 is arranged in the inserting direction before the locking tabs 54, 55.

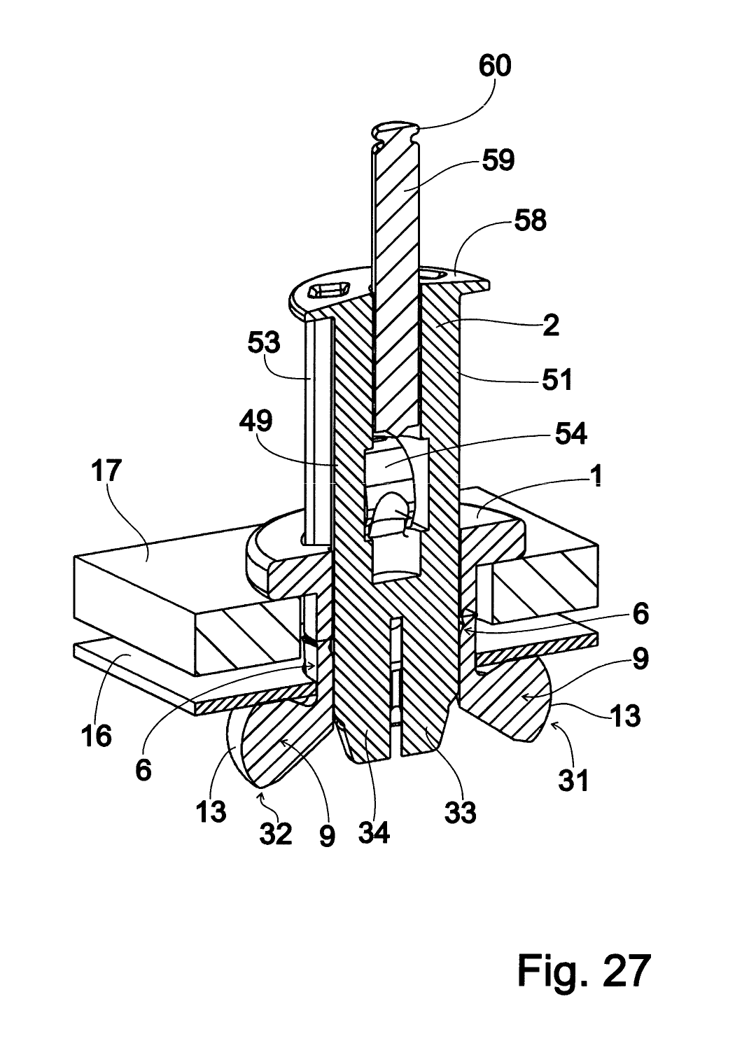

FIG. 27 shows a perspective view of a partial cut of the sixth embodiment in an arrangement corresponding with FIG. 26. However, in the arrangement according to FIG. 27, the rivet pin 2 (in accordance with the arrangement of the fifth embodiment shown in FIG. 20) is inserted to the extent that the foot sections 9 of the shorter expanding legs 29, 30 engage behind the surface of the support part 16 facing away from the contact part 17.

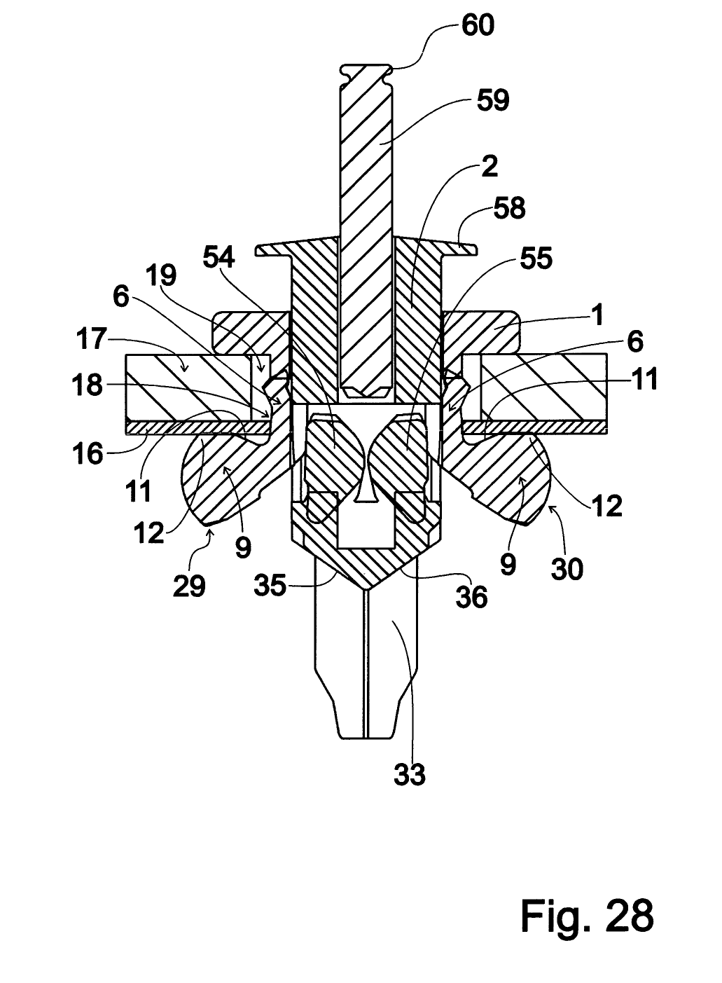

FIG. 28 shows the sixth embodiment according to FIG. 25 in cross-section through the shorter expanding legs 29, 30 in which, compared to the arrangement shown in FIG. 27, the rivet pin 2 is inserted further. Now, the pin ramps 35, 36 also contacted the sliding surfaces 15 of the shorter expanding legs 29, 30 and pressed to the outside the foot sections 9 of the shorter expanding legs 29, 30. As a result, the contact part 17 has been pulled toward the support part 16.

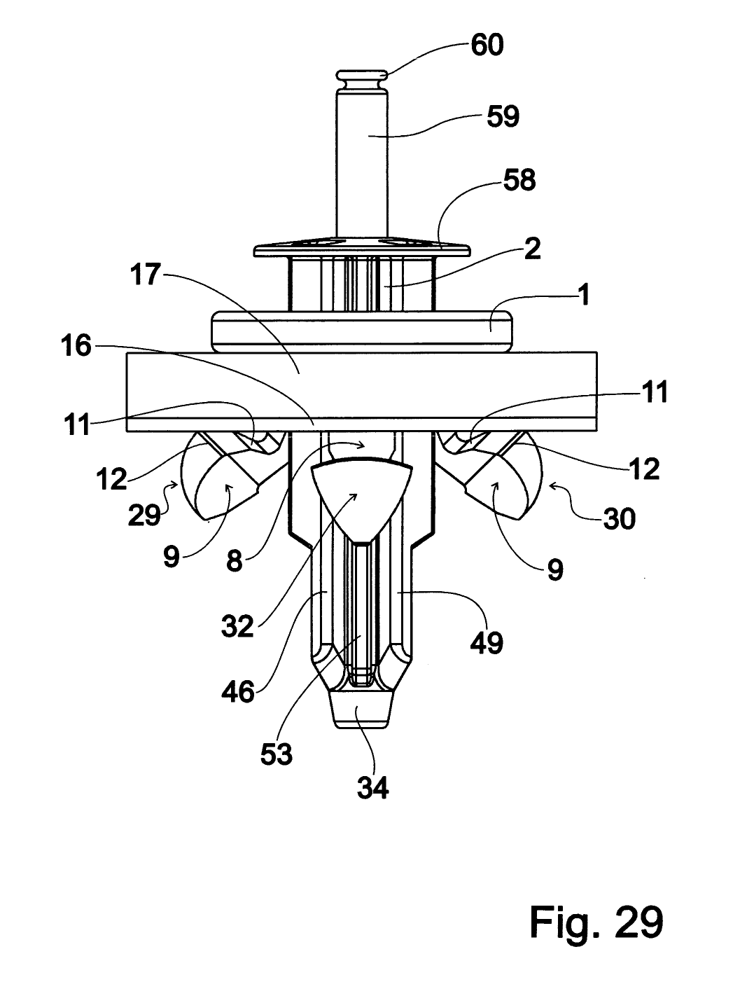

FIG. 29 shows a side view of the arrangement corresponding to FIG. 28 in which the rivet pin 2 has been partially inserted. This side view shows that now all four expanding legs 29, 30, 31, 32 now extensively engage behind the surface of the support part 16 facing away from the contact part 17.

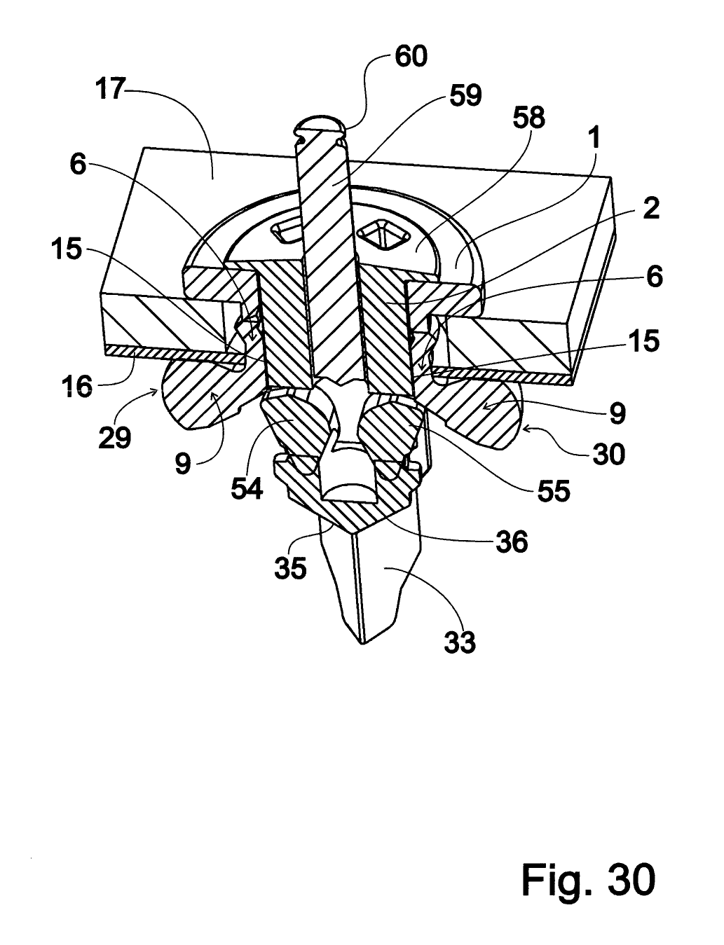

FIG. 30 shows a sectional, perspective view of the sixth embodiment according to FIG. 25 in an arrangement corresponding to FIG. 26 to FIG. 29 and in cross-section through the shorter expanding legs in which the rivet pin 2 has been completely inserted. In this completely inserted position of the rivet pin 2, the locking tabs 54, 55 are located opposite of the central sections 8 of the shorter expanding legs 29, 30, being in a relaxed position because the blocking pin 59 is just starting to be inserted.

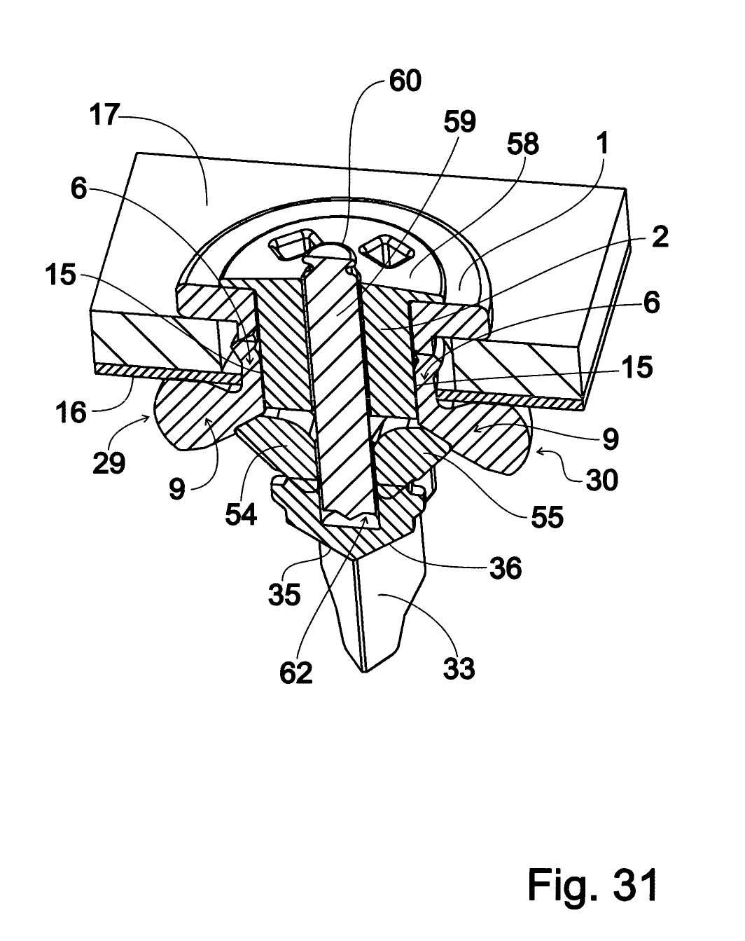

FIG. 31 shows a sectional, perspective view of the sixth embodiment according to FIG. 25 in cross-section through the shorter expanding legs 29, 30 and with the blocking pin 59 being completely inserted all the way to the grip edge 60. In this completely inserted position, the blocking pin 59 submerges into a blind recess 62 located in the rivet pin 2 and positioned opposite of the head plate 58 and presses the locking tab 54, 55 radially to the outside. As a result, the free ends of the locking tabs 54, 55 facing the head plate 58 engage behind the surfaces of the shorter expanding legs 29, 30 facing away from the support part 16 and block their radially to the inside directed movement. This results in an especially high extraction force for the expanding rivet in accordance with the sixth embodiment. The blockage can be removed by extracting the blocking pin 59.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-12. (canceled)

13. An expanding rivet defining perpendicular axial and radial directions, comprising:
a support plate;
a rivet pin movably mounted within said support plate along the axial direction;
a plurality of expanding legs extending in the axial direction, each said expanding leg including a head section connected to said support plate, a contact surface facing radially outwardly, and a pivot structure protruding radially inwardly and engageable with said rivet pin when said rivet pin is moved in the axial direction to move said expanding legs radially outwardly, said pivot structures formed as solid cap pieces disposed proximate said head section of said expanding leg and including oblique sliding surfaces protruding from the support plate and extending radially inwardly and in said axial longitudinal direction, said contact surfaces facing said support plate when said rivet pin is not in engagement with said sliding surfaces.

14. The expanding rivet of claim 13, wherein said contact surfaces are aligned parallel to said support plate when said rivet pin is not in engagement with said sliding surfaces.

15. The expanding rivet of claim 13, wherein said expanding legs each have a tapered foot section directed away from said support plate.

16. The expanding rivet of claim 13, including a pair of said expanding legs extending along the axial direction and offset in relation to each other.

17. The expanding rivet of claim 13, including a pair of expanding legs extending along said axial direction but not offset in relation to each other, one of said expanding legs including a pair of said cap pieces with a receiving chamber disposed between said cap pieces for receiving a single cap piece of the other of said expanding legs.

18. The expanding rivet of claim 13, including three of said expanding legs disposed at angles of 120 degrees with respect to one another.

19. The expanding rivet of claim 13, including four of said expanding legs disposed at angles of 90 degrees with respect to one another.

20. The expanding rivet of claim 18, wherein each said expanding leg includes a pair of opposite flat sloping sides.

21. The expanding rivet of claim 19, wherein said rivet pin includes, on an end thereof facing said expanding legs, a pair of protruding pin legs engageable with a respective pair of said expanding legs disposed diagonally opposite each other, with a pair of pin ramps provided between said pin legs, said pin ramps engageable with the other pair of said expanding legs.

22. The expanding rivet of claim 19, further including a blocking pin mounted in movable manner in said rivet pin, said rivet pin including at least two pivot-mounted locking tabs protruding over said rivet pin and which, when said blocking pin is inserted into said rivet pin, rest against respective ones of said expanding legs (29, 30).

23. The expanding rivet of claim 19, wherein said pairs of diagonally opposite expanding legs are different in length.

24. The expanding rivet of claim 23, wherein said rivet pin, when moved along the axial direction, first engages a longer pair of said expanding legs and then a shorter pair of said expanding legs.
